(19) United States
(12) Patent Application Publication
(10) Pub. No.: US 2026/0360344 A1
(43) Pub. Date: Nov. 12, 2026

(54) HUMBUCKER ELECTRIC GUITAR PICKUP WITH TWO INDIVIDUALLY SWAPPABLE MODULAR COILS

(71) Applicant: John Francis Hummer, Boone, IA (US)

(72) Inventor: John Francis Hummer, Boone, IA (US)

(21) Appl. No.: 19/665,785

(22) Filed: May 1, 2026

Related U.S. Application Data
(60) Provisional application No. 63/800,506, filed on May 6, 2025.

(51) Int. Cl. G10H 3/18

(52) U.S. Cl. CPC G10H 3/181; G10H 3/182

(57) ABSTRACT

The invention provides a modifiable pickup for an electric guitar, in a humbucker configuration: a guitar pickup that uses two wire coils to cancel out noisy interference from coil pickups. The pickup system allows each humbucker coil to be independently swapped in and out, allowing users to mix and match coils with different tonal properties.

### CROSS REFERENCE TO RELATED APPLICATIONS

This application claims priority under 35 U.S.C. § 119(e) to provisional patent application U.S. Ser. No. 63/800,506, filed May 20, 2025. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to magnetic pickups for stringed musical instruments and corresponding methods of use and manufacture, having applications in at least the music and entertainment industry. More particularly, but not exclusively, the present disclosure relates to a modifiable humbucking pickup for an electric guitar.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Electric guitar pickups are electromagnetic transducers that convert the vibrations of ferromagnetic strings into electrical signals for amplification. These devices typically consist of one or more coils of wire wound around or near permanent magnets, creating a magnetic field that interacts with the guitar strings. When a string vibrates, it disturbs this magnetic field, inducing a voltage in the coil that corresponds to the string's movement.

Single-coil pickups, while producing a clear and bright tone, are susceptible to electromagnetic interference from external sources such as fluorescent lights, transformers, and other electrical devices. This interference manifests as an audible hum or buzz that can be problematic in recording and performance environments. To address this issue, and as set forth in U.S. Pat. No. 2,896,491 to Lover, the humbucking pickup is an electromagnetic pickup for stringed musical instruments with magnetically opposed pickup coils that neutralize the effect of currents induced by adjacent electrical devices. This configuration allows the musical signal from string vibrations to be additive while canceling out external electromagnetic interference.

The tonal characteristics of a pickup are influenced by various factors including coil wire gauge, number of windings, magnet type and strength, pole piece materials, and overall construction. Different combinations of these elements produce distinct sonic qualities, from bright and articulate tones to warm and compressed sounds. However, the permanent nature of conventional pickup construction limits a musician's ability to experiment with different tonal combinations or adapt their instrument's sound for different musical contexts.

Some modular pickup systems have been developed that allow for quick replacement of entire pickup units, but these systems still require users to purchase complete assemblies rather than individual components. This approach can be costly and does not provide the granular level of customization that many musicians desire for achieving specific tonal goals.

While hand wound pickups sound great, there persistently exists a need in the art for an even better sounding pickup, such as a modifiable pickup that can be tuned by adjusting the inherent capacitance created by the pure copper coils, providing all of the benefits of hand winding, with no issues or inconsistency.

### SUMMARY

Winding can sound even better with precision that allows programmable fill patterns. The pickup can be tuned by adjusting the inherent capacitance created by the pure copper coils, that provides all of the benefits of hand winding, with no issues or inconsistency.

A carbon humbucker is a low output humbucking style guitar pickup that is open and airy. The carbon humbucker is dynamic, responsive, and picks up on every nuance. The difference can be felt. Iridium and polonium humbuckers are modern sounding pickups with an Alnico 8 magnet. The iridium and polonium humbuckers give a slightly softer high end than typical modern ceramic magnet pickups.

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to permit replacement of pieces of the pickup to improve it. For example, the player is able to swap out the metal and magnetic component parts of a pickup to change it, without needing special tools or expertise.

It is preferred the apparatus be safe, cost effective, and durable. For example, the modifiable humbucker can be adapted to resist excessive heat, static buildup, corrosion, and/or mechanical failures (e.g. cracking, crumbling, shearing, creeping) due to excessive impacts and/or prolonged exposure to tensile and/or compressive forces acting on the apparatus.]

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the modified humbucker.

Methods can be practiced which facilitate use, manufacture, assembly, maintenance, and repair of the modified humbucker which accomplish some or all of the previously stated objectives.

The modifiable humbucker can be incorporated into systems or kits which accomplish some or all of the previously stated objectives.

According to an aspect of the present disclosure, a modifiable electric guitar pickup system is provided. The system includes a base assembly configured to mount within a standard humbucker pickup cavity of an electric guitar. The base assembly includes a first coil mounting region and a second coil mounting region positioned adjacent to the first coil mounting region. The base assembly further includes a plurality of spring-loaded electrical connectors positioned within the first and second coil mounting regions. The system includes a first modular coil assembly configured to removably engage with the first coil mounting region. The first modular coil assembly includes a bobbin, a coil of wire wound around the bobbin, and a plurality of copper contact pads positioned on a bottom surface of the first modular coil assembly and configured to electrically engage with corresponding spring-loaded electrical connectors in the first coil mounting region. The system includes a second modular coil assembly configured to removably engage with the second coil mounting region. The second modular coil assembly includes a bobbin, a coil of wire wound around the bobbin, and a plurality of copper contact pads positioned on a bottom surface of the second modular coil assembly and configured to electrically engage with corresponding spring-loaded electrical connectors in the second coil mounting region. The first and second modular coil assemblies are independently removable and replaceable without requiring soldering or specialty tools.

According to other aspects of the present disclosure, the modifiable electric guitar pickup system may include one or more of the following features. The base assembly may include a bar magnet positioned between the first and second coil mounting regions, wherein the bar magnet becomes accessible for replacement when the first and second modular coil assemblies are removed. Each of the first and second modular coil assemblies may include steel slugs or adjustable steel screws positioned to interact with guitar strings. The spring-loaded electrical connectors may be pogo pins configured to provide both electrical connection and mechanical retention of the modular coil assemblies. The base assembly may include electrical traces connecting the spring-loaded electrical connectors to output terminals for connection to guitar electronics. The first and second modular coil assemblies may have standardized dimensions and electrical interfaces, allowing interchangeable use between the first and second coil mounting regions. The copper contact pads may be positioned to align with the spring-loaded electrical connectors when the modular coil assemblies are properly seated in their respective mounting regions.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a perspective view of a modular humbucker pickup with swappable coils according to an embodiment of the present disclosure.

FIG. 2 is an exploded view some of the components of the modular humbucker pickup of FIG. 1.

FIG. 3 is an environmental of several such modular humbucker pickups of FIG. 1, used in combination with an electric guitar.

FIG. 4 is a detailed, top perspective view of the modular humbucker pickup of FIG. 1, showing output cable pads and electrical traces connecting to pogo pins.

FIG. 5 is a detailed, bottom perspective view of the modular humbucker pickup of FIG. 1, illustrating pogo pin interactions and copper contact pads for coil wire termination.

FIG. 6 is a front elevation view of the modular humbucker pickup of FIG. 1.

FIG. 7 is a rear elevation view of the modular humbucker pickup of FIG. 1.

FIG. 8 is a top plan view of the modular humbucker pickup of FIG. 1.

FIG. 9 is a bottom plan view of the modular humbucker pickup of FIG. 1.

FIG. 10 is a left side elevation view of the modular humbucker pickup of FIG. 1, showing the coil configuration.

FIG. 11 is a right side elevation view of the modular humbucker pickup of FIG. 1, emphasizing the coil arrangement.

FIG. 12 is a perspective cross-sectional view of the modular humbucker pickup of FIG. 1, taken along line 12-12 of FIG. 8, showing internal contact arrangements and electrical connections.

FIG. 13 is a perspective cross-sectional view of the modular humbucker pickup of FIG. 1, taken along line 13-13 of FIG. 8, illustrating the internal structure and component relationships between the base assembly and modular coil assemblies.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Electric guitar pickups serve as transducers that convert string vibrations into electrical signals, with humbucker pickups utilizing two coils to cancel electromagnetic interference while capturing string motion. Traditional humbucker designs permanently integrate both coils into a single assembly, limiting tonal customization options for musicians and requiring complete pickup replacement to achieve different sonic characteristics.

The modular electric guitar pickup system addresses these limitations by providing independently swappable coil assemblies that may be removed and replaced without soldering or specialized tools. Each coil assembly may function as a self-contained unit with standardized electrical and mechanical interfaces, allowing musicians to mix and match coils with different tonal properties according to their preferences.

The system may utilize spring-loaded connectors and corresponding contact surfaces to establish both electrical connection and mechanical retention between the coil assemblies and a supporting base structure. This connection method may eliminate the need for permanent wiring while maintaining reliable electrical contact during instrument operation. The standardized interface design may allow coil assemblies to be interchanged between mounting positions, providing flexibility in tonal configuration.

In some cases, the modular approach may reduce costs by allowing musicians to purchase individual coil assemblies rather than complete pickup units when seeking tonal variations. The system may maintain compatibility with standard humbucker pickup cavities and mounting hardware, facilitating installation in existing instruments without modification. The tool-free operation may enable real-time tonal adjustments during performance or recording sessions, expanding creative possibilities for guitarists and sound engineers.

The modular design may also provide access to internal components that are typically sealed within conventional pickup assemblies. This accessibility may allow for additional customization options beyond coil replacement, further enhancing the versatility of the pickup system while maintaining the traditional aesthetic appearance of humbucker pickups.

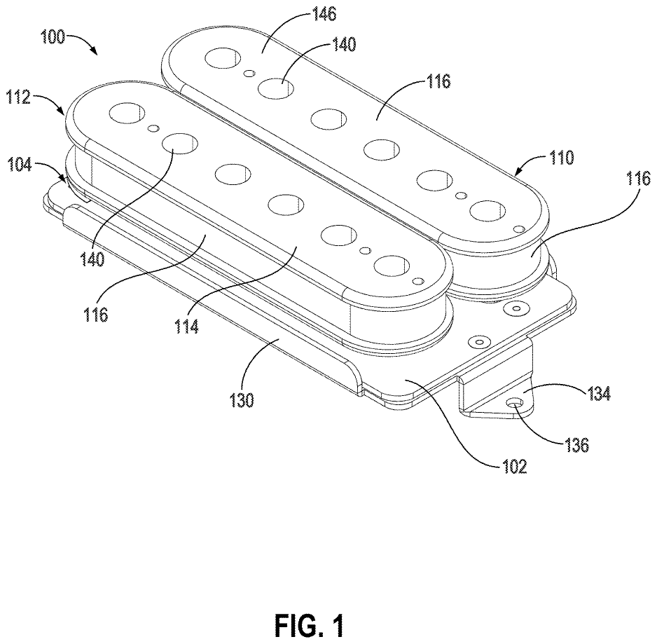

Referring to FIG. 1, a modular electric guitar pickup system 100 may include a base assembly 102 configured to mount within a humbucker pickup cavity of an electric guitar 200. The base assembly 102 may include a first coil mounting region 104 and a second coil mounting region 106 positioned adjacent to the first coil mounting region 104. The base assembly 102 may further include a plurality of spring-loaded electrical connectors 108 positioned within the first coil mounting region 104 and the second coil mounting region 106.

The modular electric guitar pickup system 100 may further include a first modular coil assembly 110 configured to removably engage with the first coil mounting region 104. The first modular coil assembly 110 may include a bobbin 114, a coil of wire 116 wound around the bobbin 114, and a plurality of copper contact pads positioned on a bottom surface 144 of the first modular coil assembly 110. The copper contact pads may be configured to electrically engage with corresponding spring-loaded electrical connectors 108 in the first coil mounting region 104.

The modular electric guitar pickup system 100 may also include a second modular coil assembly 112 configured to removably engage with the second coil mounting region 106. The second modular coil assembly 112 may include a bobbin 114, a coil of wire 116 wound around the bobbin 114, and a plurality of copper contact pads positioned on a bottom surface 144 of the second modular coil assembly 112. The copper contact pads may be configured to electrically engage with corresponding spring-loaded electrical connectors 108 in the second coil mounting region 106.

The first modular coil assembly 110 and the second modular coil assembly 112 may be independently removable and replaceable without requiring soldering or specialty tools. Each modular coil assembly 110, 112 may include coil windings that are visible around the perimeter of the respective bobbin 114. Multiple pole pieces 122, 124 may extend upward from a top surface 146 of each modular coil assembly 110, 112, with the pole pieces 122, 124 arranged in a linear configuration to correspond with guitar string 202 positions.

Pole piece openings 140 may be visible on the top surface 146 of each modular coil assembly 110, 112, accommodating the pole pieces 122, 124. The base assembly 102 may include mounting tabs 134 extending from opposite sides of the base assembly 102, providing attachment points for securing the pickup system to a guitar body 204. Each modular coil assembly 110, 112 may include a housing 148 with side walls that provide structural containment for the internal components of the respective coil assembly 110, 112.

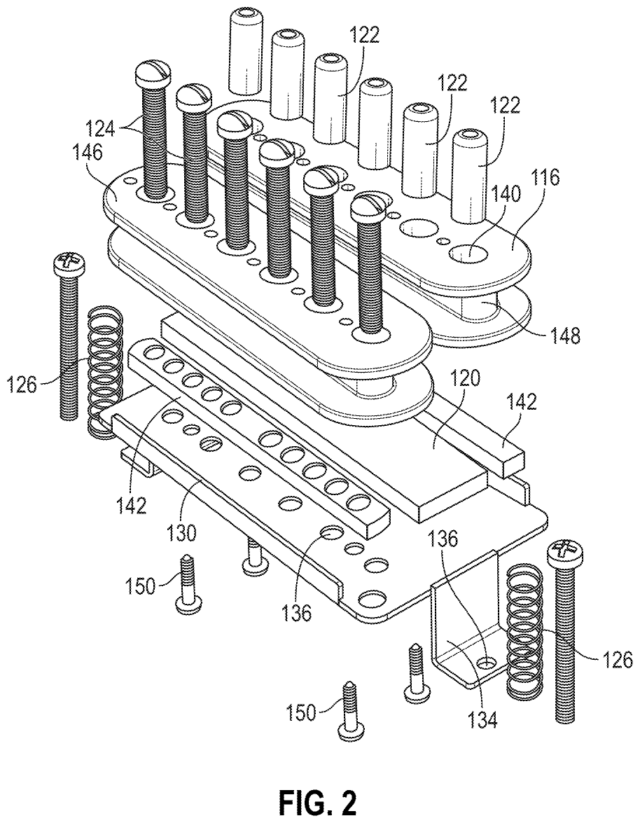

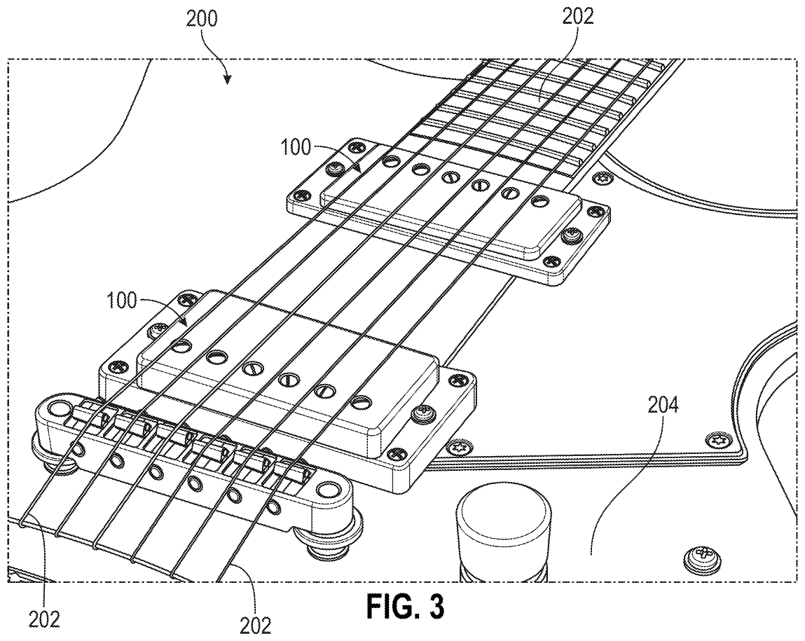

Referring to FIGS. 2-3, the pole pieces may comprise steel slugs 122 that serve as magnetic field concentrators within the modular coil assemblies 110, 112. The steel slugs 122 may be positioned to interact with guitar strings 202 when the modular electric guitar pickup system 100 is installed in an electric guitar 200. The steel slugs 122 may be embedded within or mounted to the bobbin 114 structure, providing magnetic coupling between the coil windings and the guitar strings 202 positioned above the pickup system 100.

The bar magnet 120 may be configured to provide magnetic flux to both modular coil assemblies 110, 112 when the assemblies are installed in their respective mounting regions 104, 106. The magnetic field generated by the bar magnet 120 may extend through the steel slugs 122 or adjustable steel screws 124 within each modular coil assembly 110, 112, creating localized magnetic field concentrations that interact with guitar strings 202 positioned above the pickup system. The bar magnet 120 may maintain consistent magnetic field strength across both coil mounting regions 104, 106, ensuring balanced electromagnetic coupling between the pickup system 100 and all guitar strings 202.

The bar magnet 120 may be removable without requiring tools when the first modular coil assembly 110 and the second modular coil assembly 112 are removed from the base assembly 102. The tool-free removal capability may allow the bar magnet 120 to be extracted from the base assembly 102 using manual manipulation without specialized equipment or fasteners. The bar magnet 120 may be retained within the base assembly 102 through a friction fit, magnetic attraction, or mechanical retention system that secures the magnet during operation while allowing hand removal when the coil assemblies 110, 112 are not installed.

The tool-free removal feature of the bar magnet 120 may enable easy replacement or swapping of magnets with different magnetic properties to achieve various tonal characteristics. The bar magnet 120 may be configured to slide out of the base assembly 102 when the modular coil assemblies 110, 112 are removed, providing access for magnet replacement without requiring disassembly tools or permanent modifications to the pickup system. The removable nature of the bar magnet 120 may enhance the customization capabilities of the modular electric guitar pickup system 100 by allowing magnetic field adjustments in addition to coil assembly replacement.

In some cases, the bar magnet 120 may be constructed from different magnetic materials such as alnico, ceramic, or neodymium to provide varying magnetic field strengths and tonal characteristics. The removable configuration of the bar magnet 120 may allow musicians to experiment with different magnet types to achieve desired pickup response and tonal qualities. The bar magnet 120 may maintain consistent dimensional specifications that enable interchangeability between different magnetic materials while preserving the mechanical fit within the base assembly 102.

The steel slugs 122 may function as magnetic field concentrators that focus and direct the magnetic flux generated by the base assembly 102 toward the guitar strings 202. The steel slugs 122 may interact with a bar magnet positioned within the base assembly 102 to create localized magnetic fields that extend upward toward the guitar string 202 positions. The steel slugs 122 may be constructed from ferromagnetic material that enhances the magnetic field strength at specific points corresponding to individual guitar string 202 positions.

The steel slugs 122 may be arranged in a linear configuration within each modular coil assembly 110, 112, with each steel slug 122 positioned to correspond with a specific guitar string 202. The steel slugs 122 may extend upward from the top surface 146 of the modular coil assembly 110, 112, creating magnetic field concentration points that interact with the vibrating guitar strings 202. The positioning of the steel slugs 122 may be maintained consistently across different modular coil assemblies 110, 112 to ensure proper electromagnetic coupling regardless of which assembly is installed in each mounting region 104, 106.

In some cases, the steel slugs 122 may be adjustable in height to modify the magnetic field strength relative to the guitar strings 202. The adjustable configuration may allow the steel slugs 122 to be raised or lowered within the modular coil assembly 110, 112 to optimize the magnetic field interaction with individual guitar strings 202. The height adjustment capability may provide fine-tuning of the electromagnetic coupling between each steel slug 122 and its corresponding guitar string 202, allowing for customization of the pickup response across different string positions.

The adjustable steel slugs 122 may be configured to move vertically within the pole piece openings 140 of the modular coil assembly 110, 112. The height adjustment mechanism may allow each steel slug 122 to be positioned at an optimal distance from its corresponding guitar string 202 to achieve desired magnetic field strength and pickup sensitivity. The adjustable nature of the steel slugs 122 may accommodate variations in guitar string 202 height and provide compensation for different string gauges or playing styles.

Referring to FIG. 2, the base assembly 102 may further include a bar magnet 120 positioned between the first coil mounting region 104 and the second coil mounting region 106. The bar magnet 120 may serve as the primary magnetic field source for the modular electric guitar pickup system 100, providing the magnetic flux that enables electromagnetic transduction of guitar string 202 vibrations into electrical signals. The bar magnet 120 may extend longitudinally between the two coil mounting regions 104, 106, creating a magnetic field that interacts with the pole pieces 122, 124 in both the first modular coil assembly 110 and the second modular coil assembly 112.

As shown in FIG. 2, the bar magnet 120 may be positioned within the base assembly 102 in a location that becomes exposed when the first modular coil assembly 110 and the second modular coil assembly 112 are removed from their respective mounting regions 104, 106. The positioning of the bar magnet 120 between the coil mounting regions 104, 106 may allow the magnet to remain accessible for inspection, adjustment, or replacement when the modular coil assemblies 110, 112 are not installed. The bar magnet 120 may be secured within the base assembly 102 through a retention mechanism that maintains the magnet's position during normal operation while allowing removal when desired.

With continued reference to FIG. 2, the bar magnet 120 may become accessible for replacement when the first modular coil assembly 110 and the second modular coil assembly 112 are removed from the base assembly 102. The removal of the modular coil assemblies 110, 112 may expose the bar magnet 120, providing direct access to the magnetic component without requiring disassembly of the base assembly 102 or other pickup components. The accessibility of the bar magnet 120 may enable musicians and technicians to replace the magnet with different magnetic materials or field strengths to achieve desired tonal characteristics.

The pole pieces may alternatively comprise adjustable steel screws 124 positioned to interact with guitar strings 202 when the modular electric guitar pickup system 100 is installed in an electric guitar 200. The adjustable steel screws 124 may be visible through the pole piece openings 140 on the top surface 146 of the first modular coil assembly 110. The adjustable steel screws 124 may serve as magnetic field concentrators that interact with the coil windings and the base assembly 102 to create electromagnetic coupling with guitar strings 202 positioned above the pickup system.

The adjustable steel screws 124 may be threaded components that may be rotated to adjust their vertical position within the pole piece openings 140 of the modular coil assembly 110, 112. The threaded configuration may allow each adjustable steel screw 124 to be raised or lowered relative to the top surface 146 of the modular coil assembly 110, 112 by rotating the screw in the appropriate direction. The adjustable steel screws 124 may extend upward from the bobbin 114 structure through the pole piece openings 140, providing variable height positioning for optimizing electromagnetic interaction with individual guitar strings 202.

The adjustable steel screws 124 may be configured to be adjusted in height to modify magnetic field strength relative to the guitar strings 202. The height adjustment capability may allow each adjustable steel screw 124 to be positioned at an optimal distance from its corresponding guitar string 202 to achieve desired magnetic field strength and pickup sensitivity. The adjustable steel screws 124 may provide fine-tuning control over the electromagnetic coupling between the modular coil assembly 110, 112 and individual guitar strings 202, allowing for customization of pickup response across different string positions.

The adjustable steel screws 124 may maintain their magnetic field concentration properties throughout the adjustment range, providing consistent electromagnetic coupling with the guitar strings 202 at various height settings. The threaded engagement between the adjustable steel screws 124 and the bobbin 114 may provide mechanical retention that maintains the selected height position during instrument operation while allowing intentional adjustment when desired. The adjustable steel screws 124 may accommodate variations in guitar string 202 height and provide compensation for different string gauges or playing styles through their height adjustment capability.

In some cases, the adjustable steel screws 124 may be positioned within both the first modular coil assembly 110 and the second modular coil assembly 112, providing height adjustment capability for all pole pieces within the modular electric guitar pickup system 100. The adjustable steel screws 124 may be arranged in a linear configuration corresponding to guitar string 202 spacing, with each adjustable steel screw 124 positioned to interact with a specific guitar string 202. The height adjustment feature of the adjustable steel screws 124 may enhance the versatility of the modular coil assemblies 110, 112 by providing additional customization options beyond coil replacement, allowing musicians to optimize the magnetic field interaction for their specific instrument setup and playing preferences.

The springs shown in FIG. 2 are individual springs that can be used in connection with components of the modular electric guitar pickup system(s) 100 to provide a spring force 126. Springs can be used with components like the connectors 108, pole pieces 122, 124, pogo pins 134, or any other suitable component that would benefit by a resilient force being applied to same.

In some embodiments, an electric guitar 200 may include anywhere between one and three modular electric guitar pickup systems 100 installed in corresponding pickup cavities within the guitar body 204. A single pickup configuration may position the modular electric guitar pickup system 100 in a bridge position, a middle position, or a neck position according to the desired tonal characteristics. A dual pickup configuration may position modular electric guitar pickup systems 100 in bridge and neck positions (e.g., the embodiment of FIG. 3), or in bridge and middle positions, or in middle and neck positions. A triple pickup configuration may position modular electric guitar pickup systems 100 in bridge, middle, and neck positions simultaneously. Each modular electric guitar pickup system 100 may operate independently, allowing musicians to select different combinations of modular coil assemblies 110, 112 for each pickup position to achieve a wide range of tonal variations across the instrument. The modular nature of each pickup system 100 may enable customization of individual pickup positions without affecting the configuration of other installed pickup systems.

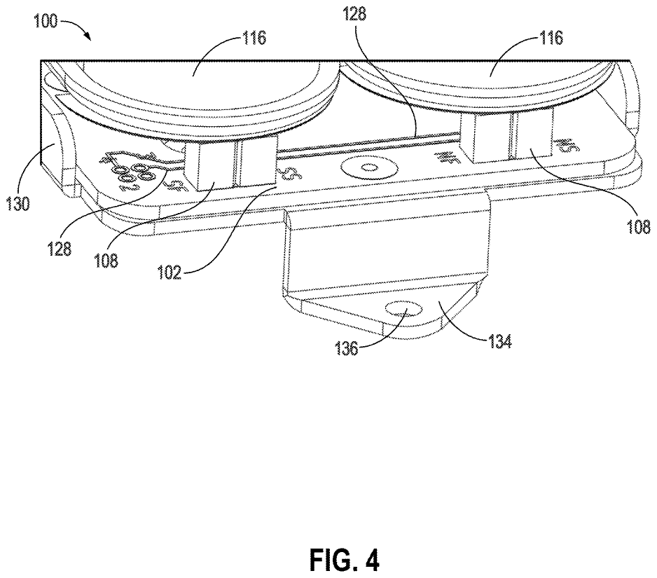

Referring to FIG. 4, the base assembly 102 can include a mounting platform 130 that provides structural support for the modular components of the modular electric guitar pickup system 100. The mounting platform 130 may be configured to fit within a standard humbucker pickup cavity, maintaining dimensional compatibility with conventional pickup installations. The mounting platform 130 may extend beneath both the first coil mounting region 104 and the second coil mounting region 106, providing a foundation for the electrical connection system and mechanical support structure.

The first coil mounting region 104 and the second coil mounting region 106 may be positioned on the mounting platform 130 adjacent to each other. As shown in FIG. 2, the mounting platform 130 may accommodate both coil mounting regions 104, 106 while providing the infrastructure for electrical connectivity between the modular coil assemblies 110, 112 and guitar electronics. The mounting platform 130 may serve as the primary structural element that maintains the spatial relationship between the first coil mounting region 104 and the second coil mounting region 106.

The mounting tabs 134 may extend from the mounting platform 130 to provide attachment points for securing the pickup system to a guitar body 204. The mounting tabs 134 may include mounting holes 136 positioned to accept standard mounting hardware for installation in a humbucker pickup cavity. The mounting holes 136 may be configured to accommodate fasteners that secure the base assembly 102 within the guitar body 204, ensuring stable positioning during instrument operation.

The base assembly 102 may further include electrical traces 128 connecting the pogo pins 132 to output terminals for connection to guitar electronics. The electrical traces 128 may be visible on the mounting platform 130, providing conductive pathways that route electrical signals from the spring-loaded electrical connectors 108 to designated output connection points. The electrical traces 128 may be implemented as copper traces on a printed circuit board within the base assembly 102, providing reliable signal transmission between the modular coil assemblies 110, 112 and external guitar electronics.

The electrical traces 128 may connect the pogo pins 132 in the first coil mounting region 104 and the second coil mounting region 106 to output terminals positioned on the base assembly 102. The electrical traces 128 may route signals from each spring-loaded electrical connector 108 to specific output points that interface with guitar wiring harnesses or electronic control systems. The electrical traces 128 may maintain signal integrity while providing the necessary electrical pathways for transmitting pickup signals to amplification systems.

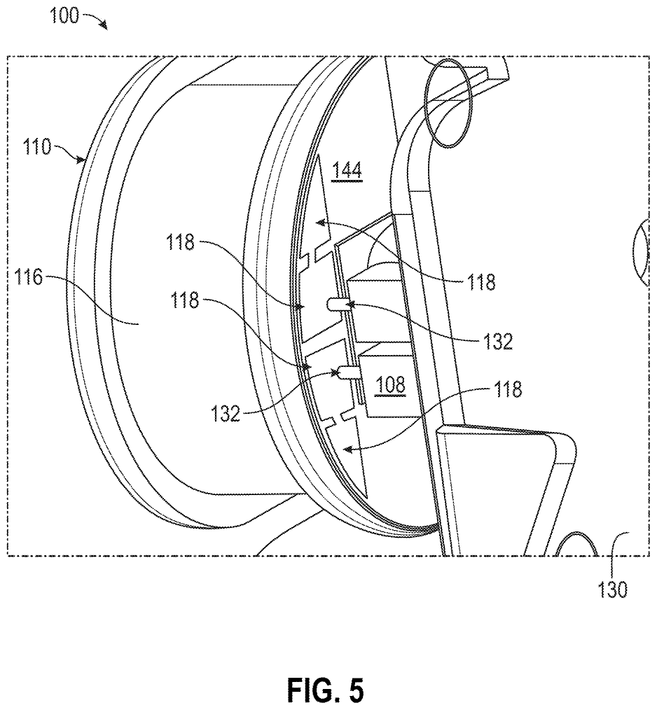

Referring to FIG. 5, the base assembly 102 may include a plurality of spring-loaded electrical connectors 108 positioned within the first coil mounting region 104 and the second coil mounting region 106. The spring-loaded electrical connectors 108 may be configured to provide both electrical connection and mechanical retention for the first modular coil assembly 110 and the second modular coil assembly 112. The spring-loaded electrical connectors 108 may extend upward from the mounting platform 130 to engage with corresponding copper contact pads 118 on the modular coil assemblies 110, 112 when the assemblies are installed in their respective mounting regions 104, 106.

The spring-loaded electrical connectors 108 may comprise pogo pins 132 that are positioned to align with the copper contact pads 118 on the bottom surface 144 of the modular coil assemblies 110, 112. The pogo pins 132 may be arranged in a pattern designed to correspond with the positioning of the copper contact pads 118 on each modular coil assembly 110, 112. The pogo pins 132 may provide spring-loaded contact pressure that maintains electrical connection while allowing for easy insertion and removal of the modular coil assemblies 110, 112.

The pogo pins 132 may be configured to provide both electrical connection and mechanical retention of the modular coil assemblies 110, 112. The spring-loaded nature of the pogo pins 132 may allow the connectors to compress when a modular coil assembly 110, 112 is inserted into a mounting region 104, 106, then extend to maintain contact pressure against the copper contact pads 118. This spring action may ensure reliable electrical contact during instrument operation while facilitating tool-free removal of the modular coil assemblies 110, 112.

The copper contact pads 118 may be positioned on the bottom surface 144 of each modular coil assembly 110, 112 to provide electrical connection points for interfacing with the base assembly 102. The copper contact pads 118 may serve as the primary electrical interface between the modular coil assemblies 110, 112 and the spring-loaded electrical connectors 108 within the first coil mounting region 104 and the second coil mounting region 106. The copper contact pads 118 may be configured to establish reliable electrical contact with the pogo pins 132 when the modular coil assemblies 110, 112 are installed in their respective mounting regions 104, 106.

The first and second ends of the coil of wire 116 may be electrically connected to respective copper contact pads 118 positioned on the bottom surface 144 of each modular coil assembly 110, 112. The coil of wire 116 may terminate at designated copper contact pads 118 that correspond to the positive and negative terminals of the electromagnetic pickup element. The electrical connection between the coil ends and the copper contact pads 118 may provide the signal transmission pathway that routes the electromagnetic pickup signal from the coil windings to the base assembly 102 through the spring-loaded electrical connectors 108.

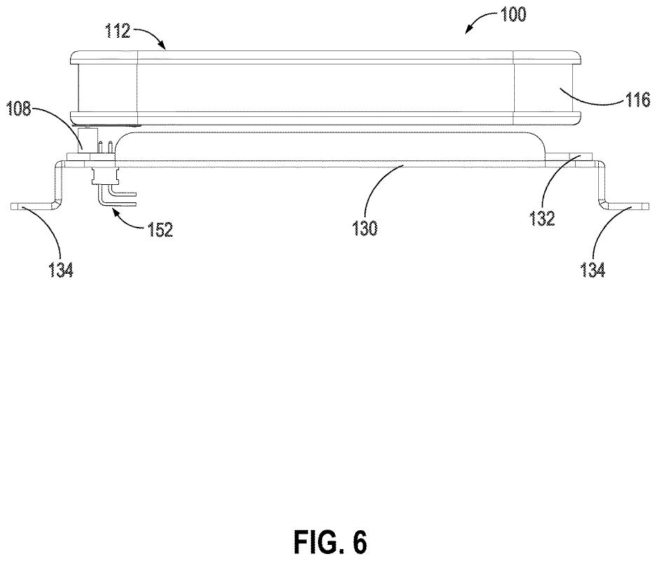

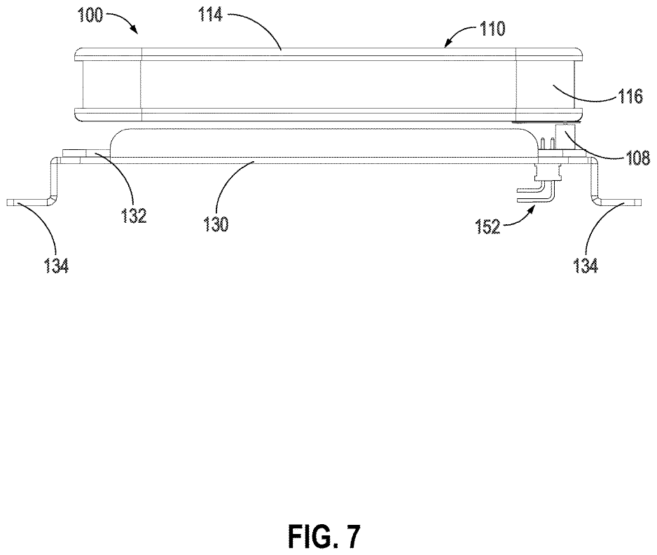

Referring to FIGS. 6-7, a modular coil assembly 110, 112 may include a bobbin 114 that provides structural support for the electromagnetic components of the pickup system. The bobbin 114 may serve as the foundation around which a coil of wire 116 is wound to create the electromagnetic transduction element. The bobbin 114 may be constructed from a non-conductive material that maintains the positioning of the coil windings while providing mechanical stability for the modular coil assembly 110, 112.

The coil of wire 116 may be wound around the bobbin 114 to form coil windings that generate the electromagnetic field for string detection. The coil of wire 116 may have first and second ends that terminate at electrical connection points within the modular coil assembly 110, 112. The coil windings may be distributed around the perimeter of the bobbin 114 in a configuration that optimizes electromagnetic coupling with guitar strings 202 while maintaining the compact form factor of the modular assembly.

The modular coil assembly 110, 112 may include a housing 148 that contains the coil windings and provides structural integrity for the assembly. The housing 148 may encapsulate the coil of wire 116 and protect the internal components from environmental factors while maintaining the dimensional specifications for compatibility with the base assembly mounting regions 104, 106. The housing 148 may be configured to maintain the positioning of the coil windings relative to the bobbin 114 during installation and removal operations.

The housing 148 may include side walls that define the perimeter of the modular coil assembly 110, 112. The side walls may provide lateral containment for the coil windings and establish the external boundaries of the modular assembly. The side walls may be configured to maintain consistent dimensions across different modular coil assemblies 110, 112, enabling standardized interfaces between the assemblies and the base assembly mounting regions 104, 106.

The side walls may extend vertically to create a containment structure that houses the coil of wire 116 and associated components. The side walls may be integrated with the housing 148 to form a unified structure that protects the internal components while providing the mechanical interface points for engagement with the base assembly. The side walls may maintain the structural integrity of the modular coil assembly 110, 112 during repeated installation and removal cycles.

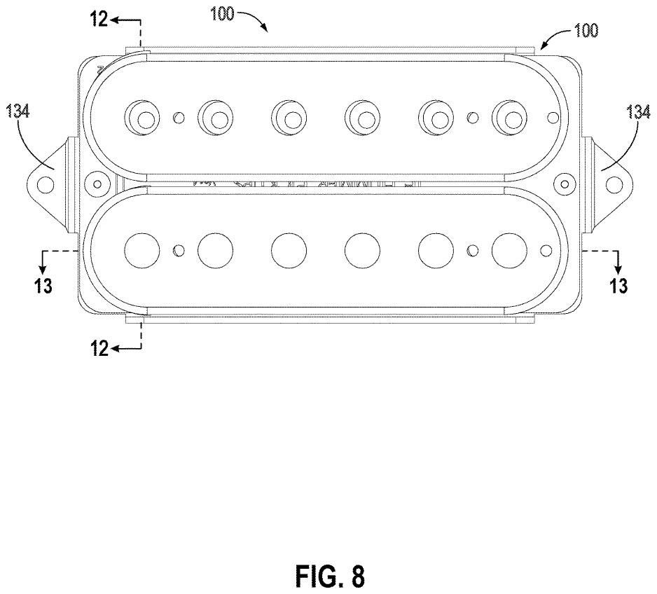

As shown in FIG. 8, the mounting tabs 134 may extend from opposite ends of the base assembly 102, providing balanced support for the modular electric guitar pickup system 100. The mounting platform 130 may maintain the traditional humbucker pickup geometry while incorporating the modular functionality that allows independent removal and replacement of each coil assembly 110, 112. The mounting holes 136 may be positioned within the mounting tabs 134 to align with standard pickup mounting configurations used in electric guitars 200.

The pole piece openings 140 may correspond to standard guitar string 202 spacing, with each opening positioned to accommodate a specific pole piece 122, 124 that interacts with an individual guitar string 202. The pole piece openings 140 may maintain consistent positioning across both the first modular coil assembly 110 and the second modular coil assembly 112, creating a symmetrical arrangement that preserves the traditional humbucker pickup geometry. The pole piece openings 140 may be sized to provide adequate clearance for the pole pieces 122, 124 while minimizing exposure of the internal components to environmental factors.

The side walls of the housing 148 may provide lateral structural protection while maintaining the dimensional specifications for compatibility with the base assembly 102. The side walls may extend vertically to create containment boundaries that house the bobbin 114 and coil of wire 116 within each modular coil assembly 110, 112. The side walls may be configured to maintain consistent external dimensions across different modular coil assemblies 110, 112, enabling standardized interfaces with the first coil mounting region 104 and the second coil mounting region 106.

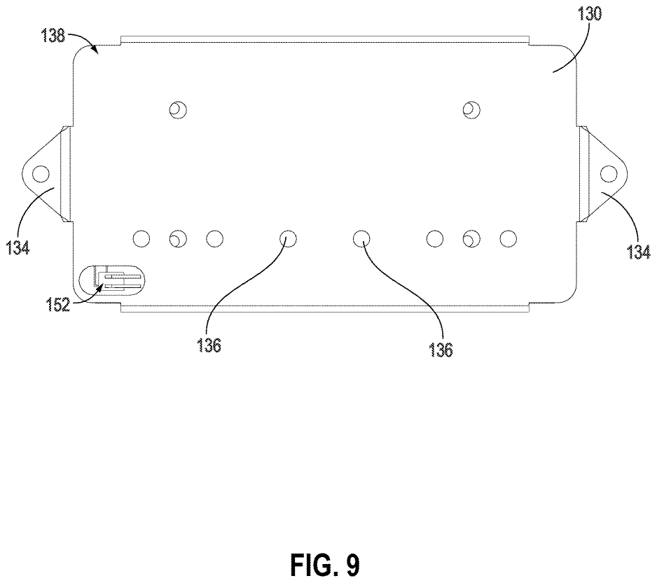

Referring to FIG. 9, the bottom view of the modular electric guitar pickup system 100 may reveal the mounting platform 130 extending beneath both the first coil mounting region 104 and the second coil mounting region 106. The mounting tabs 134 may be visible extending from the sides of the base assembly 102, with the mounting holes 136 positioned in the mounting tabs 134 for securing the pickup system to a guitar body 204. The mounting platform 130 may provide the mechanical foundation that supports the electrical connection infrastructure while maintaining compatibility with standard humbucker pickup installations.

The electrical traces 128 may be positioned on the mounting platform 130 to connect the spring-loaded electrical connectors 108 to output terminals for connection to guitar electronics. The electrical traces 128 may be configured to route signals from both the first coil mounting region 104 and the second coil mounting region 106 to common output points on the base assembly 102. The electrical traces 128 may provide the electrical infrastructure that enables the modular coil assemblies 110, 112 to function as a unified pickup system while maintaining individual coil replaceability.

The copper contact pads 118 may be positioned to align with the spring-loaded electrical connectors 108 when the modular coil assemblies 110, 112 are properly seated in their respective mounting regions 104, 106. The positioning of the copper contact pads 118 may correspond to the arrangement of the pogo pins 132 within the first coil mounting region 104 and the second coil mounting region 106, ensuring proper electrical contact when the modular coil assemblies 110, 112 are installed. The alignment between the copper contact pads 118 and the pogo pins 132 may be maintained through standardized positioning that remains consistent across different modular coil assemblies 110, 112.

The copper contact pads 118 may be configured to make direct physical contact with the corresponding pogo pins 132 when the modular coil assemblies 110, 112 are inserted into the mounting regions 104, 106. The copper contact pads 118 may provide conductive surfaces that interface with the spring-loaded electrical connectors 108 to establish the electrical pathway between the coil windings and the electrical traces 128 within the base assembly 102. The copper material of the contact pads may provide low-resistance electrical connection while maintaining durability during repeated installation and removal cycles.

Again with reference to FIG. 9, the modular electric guitar pickup system 100 may include a pickup cover 138 that encloses the first modular coil assembly 110 and the second modular coil assembly 112. The pickup cover 138 may provide external protection for the internal components of the modular coil assemblies 110, 112 while maintaining the traditional aesthetic appearance of a humbucker pickup. The pickup cover 138 may be positioned over the top surface 146 of each modular coil assembly 110, 112, creating a unified external appearance that conceals the modular nature of the internal components.

The pickup cover 138 may maintain the traditional visual appearance of a humbucker pickup while accommodating the modular functionality of the coil assemblies 110, 112. The pickup cover 138 may conceal the removable nature of the first modular coil assembly 110 and the second modular coil assembly 112, presenting a conventional humbucker appearance to observers while providing the internal modularity for coil replacement. The pickup cover 138 may be constructed from materials that provide durability and electromagnetic shielding while maintaining the aesthetic characteristics associated with traditional humbucker pickups.

The pickup cover 138 may include multiple pole piece openings 140 arranged in a linear pattern along the length of each modular coil assembly 110, 112. The pole piece openings 140 may be configured to allow the pole pieces 122, 124 to extend through the pickup cover 138 for electromagnetic interaction with guitar strings 202 positioned above the pickup system. The pole piece openings 140 may be precisely positioned to align with the pole pieces within each modular coil assembly 110, 112, ensuring proper clearance for the steel slugs 122 or adjustable steel screws 124 to extend upward toward the guitar string 202 positions.

The housing 148 may work in conjunction with the pickup cover 138 to provide comprehensive structural protection for the modular coil assemblies 110, 112. The housing 148 may include the side walls that define the perimeter boundaries of each modular coil assembly 110, 112, while the pickup cover 138 may provide protection for the top surface 146 of the assemblies. The combination of the housing 148 and the pickup cover 138 may create a complete enclosure system that protects the coil windings and internal components from physical damage and environmental exposure.

The structural protection provided by the housing 148 and the pickup cover 138 may enable the modular coil assemblies 110, 112 to withstand the mechanical stresses associated with repeated installation and removal cycles. The housing 148 may protect the coil windings and copper contact pads 118 during handling, while the pickup cover 138 may shield the pole pieces 122, 124 and pole piece openings 140 from contamination or damage. The combined protection system may maintain the integrity of the modular coil assemblies 110, 112 throughout their operational life while preserving the electromagnetic performance characteristics of the pickup system.

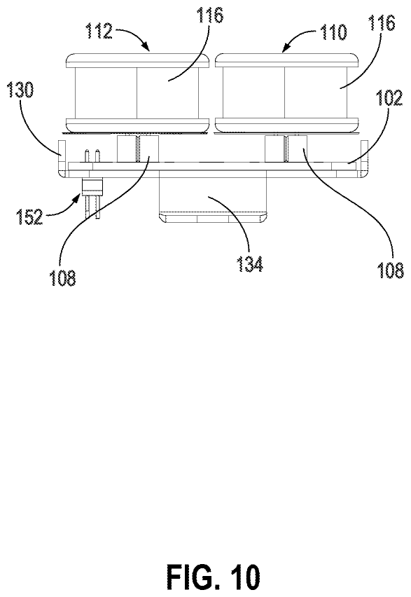

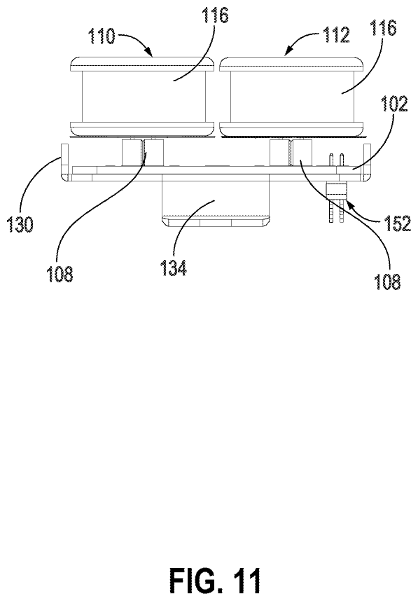

Referring to FIGS. 10-11, the modular coil assemblies 110, 112 may be configured as self-contained modules with standardized dimensions that allow interchangeable use between the first and second coil mounting regions 104, 106. The standardized dimensions may ensure that any modular coil assembly 110, 112 may be installed in either mounting region 104, 106 without modification to the base assembly or the coil assembly 110, 112 itself. The standardized electrical interfaces may provide consistent connection points that align with the spring-loaded electrical connectors regardless of which mounting region 104, 106 the assembly occupies.

The first modular coil assembly 110 and the second modular coil assembly 112 may be positioned adjacent to each other in a parallel configuration that maintains the traditional humbucker pickup geometry. The modular coil assemblies 110, 112 may share common dimensional specifications that enable interchangeability between mounting positions while preserving the electromagnetic characteristics of the pickup system. The standardized interfaces may facilitate mixing and matching of different coil assemblies 110, 112 according to tonal preferences without requiring modifications to the base assembly.

The bobbin 114 and coil of wire 116 may be integrated into a unified assembly that maintains consistent electromagnetic properties while providing the mechanical interfaces for connection to the base assembly. The first and second ends of the coil of wire 116 may be routed to the copper contact pads positioned on the bottom surface of the modular coil assembly 110, 112, establishing the electrical connection points that interface with the pogo pins in the base assembly. The modular construction may allow different coil assemblies 110, 112 with varying electromagnetic characteristics to be interchanged while maintaining the standardized mechanical and electrical interfaces.

The cross-sectional view may illustrate the positioning of the bar magnet 120 within the base assembly 102 and the relationship between the magnet and the surrounding components. The bar magnet 120 may be positioned to provide optimal magnetic field distribution to both the first coil mounting region 104 and the second coil mounting region 106 while remaining accessible when the modular coil assemblies 110, 112 are removed. The bar magnet 120 may be oriented to create magnetic field lines that extend upward through the pole pieces 122, 124 of the installed modular coil assemblies 110, 112.

The bar magnet 120 may interact with the pole pieces 122, 124 within the first modular coil assembly 110 to create the electromagnetic field configuration for string detection. The magnetic flux from the bar magnet 120 may flow through the steel slugs 122 or adjustable steel screws 124, creating magnetic field concentrations that extend toward the guitar string 202 positions. The bar magnet 120 may provide the magnetic field source that enables both modular coil assemblies 110, 112 to function as electromagnetic transducers when installed in the base assembly 102.

The bar magnet 120 may be configured to interact with the pole pieces 126 of the modular coil assemblies 110, 112 to create the magnetic field pattern for pickup operation. The bar magnet 120 may provide magnetic flux that flows through the steel slugs 122 within the modular coil assemblies 110, 112, creating localized magnetic fields at each pole piece position. The magnetic field generated by the bar magnet 120 may extend upward through the coil windings and pole pieces 126, establishing the electromagnetic coupling between the pickup system and the guitar strings 202.

The steel slugs 122 may maintain their magnetic field concentration properties throughout the adjustment range, providing consistent electromagnetic coupling with the guitar strings 202 at various height settings. The adjustable steel slugs 122 may be secured at selected height positions through mechanical retention mechanisms that prevent unwanted movement during instrument operation while allowing intentional adjustment when desired. The height adjustment capability may enhance the versatility of the modular coil assemblies 110, 112 by providing additional customization options beyond coil replacement.

Each modular coil assembly 110, 112 may include pole pieces that extend upward from the top surface 146 of the respective assembly 110, 112. The pole pieces may be positioned to interact with guitar strings 202 when the pickup system is installed in an electric guitar 202. The pole pieces may be arranged in a linear pattern that corresponds to guitar string 202 spacing, with the positioning maintained consistently across different modular coil assemblies 110, 112 to ensure proper electromagnetic coupling regardless of which assembly is installed in each mounting region 104, 106.

The copper contact pads 118 may be positioned on the bottom surface 144 of both the first modular coil assembly 110 and the second modular coil assembly 112 in a standardized pattern that enables interchangeable use between mounting regions 104, 106. The standardized positioning of the copper contact pads 118 may allow any compatible modular coil assembly 110, 112 to be installed in either the first coil mounting region 104 or the second coil mounting region 106 without modification to the electrical interface. The copper contact pads 118 may maintain consistent spacing and arrangement across different modular coil assemblies 110, 112 to ensure proper alignment with the pogo pins 132 regardless of which mounting region 104, 106 each assembly occupies.

The engagement mechanism 152 may maintain the alignment between the copper contact pads 118 and the pogo pins 132 throughout the operational life of the pickup system. The mechanical retention provided by the engagement mechanism 152 may prevent displacement of the modular coil assemblies 110, 112 that could disrupt the electrical connection between the copper contact pads 118 and the spring-loaded electrical connectors 108. The engagement mechanism 152 may accommodate the dimensional tolerances of the modular coil assemblies 110, 112 while maintaining consistent electrical contact pressure through the spring-loaded interface.

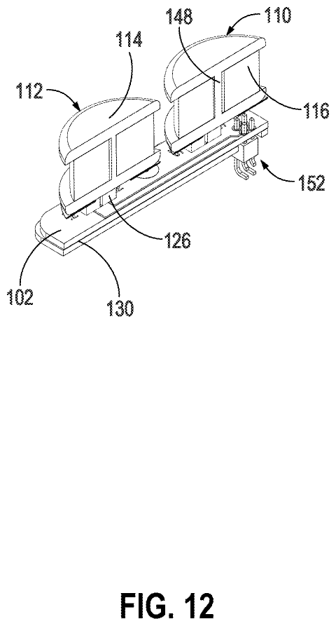

Referring to FIG. 12, the cross-sectional view may reveal the internal structure of the spring-loaded electrical connectors 108 and their interaction with the modular coil assemblies 110, 112. The pogo pins 132 may extend upward from the mounting platform 130 within the first coil mounting region 104 and the second coil mounting region 106. The pogo pins 132 may be positioned to make direct contact with the copper contact pads 118 on the bottom surface 144 of the first modular coil assembly 110 when the assembly is properly seated in the first coil mounting region 104.

The pogo pins 132 may provide mechanical retention by creating a spring-loaded engagement between the base assembly 102 and the modular coil assemblies 110, 112. The spring force 126 generated by the pogo pins 132 may hold the modular coil assemblies 110, 112 in position within their respective mounting regions 104, 106 while maintaining electrical continuity. The pogo pins 132 may compress under the weight and insertion force of the modular coil assemblies 110, 112, then provide upward spring pressure to maintain contact with the copper contact pads 118 during operation.

The electrical traces 128 may be configured to connect the first modular coil assembly 110 and the second modular coil assembly 112 in series with opposite polarity to provide hum-canceling operation. The electrical traces 128 may route the positive terminal of the first modular coil assembly 110 to the negative terminal of the second modular coil assembly 112, creating a series connection that cancels electromagnetic interference while preserving the desired guitar signal. The electrical traces 128 may facilitate this series connection through the pogo pins 132 and copper contact pads 118 interface, maintaining the hum-canceling functionality of traditional humbucker pickups.

The electrical traces 128 may be designed to accommodate the standardized electrical interface of the modular coil assemblies 110, 112, allowing different coil assemblies 110, 112 to be connected in the proper series configuration regardless of which mounting region 104, 106 each assembly occupies. The electrical traces 128 may provide consistent signal routing that maintains the opposite polarity relationship between the two coil positions, ensuring hum-canceling operation when any combination of compatible modular coil assemblies 110, 112 is installed in the first coil mounting region 104 and the second coil mounting region 106.

An engagement mechanism 152 may facilitate the removable connection between the modular coil assemblies 110, 112 and the base assembly 102. The engagement mechanism 152 may provide mechanical retention that secures the modular coil assemblies 110, 112 within their respective mounting regions 104, 106 while maintaining electrical contact between the copper contact pads 118 and the pogo pins 132. The engagement mechanism 152 may utilize the spring force 126 generated by the pogo pins 132 to create a retention system that holds the modular coil assemblies 110, 112 in position during instrument operation.

The engagement mechanism 152 may be configured to provide both electrical connection and mechanical retention through the interaction between the copper contact pads 118 and the spring-loaded electrical connectors 108. The spring-loaded nature of the pogo pins 132 may create upward pressure against the copper contact pads 118, generating the mechanical retention force that maintains the positioning of the modular coil assemblies 110, 112 within the mounting regions 104, 106. The engagement mechanism 152 may allow for tool-free installation and removal of the modular coil assemblies 110, 112 while providing secure retention during normal instrument operation.

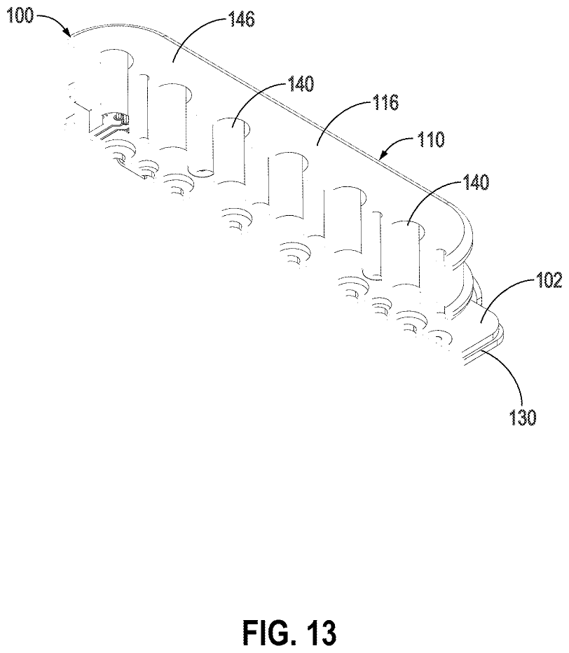

As shown in FIG. 13, the pole piece openings 140 may be arranged in a linear configuration within each modular coil assembly 110, 112, with each steel slug 122 and/or screw 124 positioned to correspond with a specific guitar string 202. The steel slugs 122 and/or adjustable steel screws 124 may extend upward through the pole piece openings 140 of the modular coil assemblies 110, 112, creating magnetic field concentration points that interact with the vibrating guitar strings 202. The positioning of pole piece openings 140 may be maintained consistently across different modular coil assemblies 110, 112 to ensure proper electromagnetic coupling regardless of which assembly is installed in each mounting region 104, 106.

### Assemblies, Installations and Methods of Use

The assembly and installation process for the modular electric guitar pickup system may be accomplished through a series of straightforward steps that eliminate the need for soldering or specialty tools. The process may begin with the preparation of the base assembly, which may be positioned for receiving the modular coil assemblies. The spring-loaded electrical connectors within each coil mounting region may be verified to be in their extended position, ready to receive the corresponding contact surfaces from the modular coil assemblies.

Installation of each modular coil assembly may commence by positioning the assembly above its designated mounting region on the base assembly. The modular coil assembly may be oriented to align the copper contact pads on the bottom surface with the corresponding spring-loaded electrical connectors in the mounting region. The alignment process may be facilitated by the standardized positioning of both the contact pads and the spring-loaded connectors, which may be configured to guide the assembly into proper position during installation.

The modular coil assembly may be lowered into the mounting region until the copper contact pads make initial contact with the spring-loaded electrical connectors. The spring-loaded nature of the connectors may allow the pogo pins to compress as the modular coil assembly is pressed downward into the mounting region. The compression of the pogo pins may create a spring force that pushes upward against the copper contact pads, establishing both electrical connection and mechanical retention simultaneously.

As the modular coil assembly is fully seated in the mounting region, the copper contact pads may come into complete contact with the compressed pogo pins. The spring force generated by the compressed pogo pins may maintain constant pressure against the copper contact pads, ensuring reliable electrical connection while providing the mechanical retention force that secures the modular coil assembly in position. The engagement between the contact pads and the pogo pins may create a stable connection that maintains electrical continuity during instrument operation.

The modular coil assemblies may be configured to removably engage with the base assembly through electrical and mechanical connection of the copper contact pads with corresponding spring-loaded electrical connectors. The modular coil assembly construction may facilitate this removable engagement by providing standardized contact surfaces and mechanical interfaces that align with the base assembly connection points. The self-contained nature of each modular coil assembly may enable independent installation and removal without affecting the other coil assembly or requiring modifications to the base assembly structure.

The mechanical retention provided by the spring-loaded electrical connectors may eliminate the need for additional fasteners or retention mechanisms to secure the modular coil assemblies within their mounting regions. The spring force may be sufficient to maintain the positioning of the modular coil assemblies during normal guitar playing and handling, while still allowing for easy removal when desired. The retention force may be calibrated to provide secure holding power without requiring excessive force for installation or removal.

Removal of a modular coil assembly may be accomplished by applying upward force to overcome the spring pressure of the pogo pins. The modular coil assembly may be grasped and pulled upward, causing the pogo pins to extend as the copper contact pads separate from the spring-loaded connectors. The removal process may require only manual force without the need for tools or special procedures. The pogo pins may return to their extended position as the modular coil assembly is lifted away from the mounting region.

The tool-free installation and removal process may enable real-time coil swapping during performance or recording sessions. Musicians may remove one modular coil assembly and replace it with another assembly having different tonal characteristics without interrupting the performance or requiring technical assistance. The standardized interface may allow any compatible modular coil assembly to be installed in either mounting region, providing flexibility in coil selection and positioning.

Installation of the complete modular electric guitar pickup system into a guitar body may be accomplished using the mounting tabs and mounting holes provided on the base assembly. The mounting tabs may extend from opposite sides of the base assembly, positioning the mounting holes at locations that correspond to standard humbucker pickup mounting configurations. The mounting holes may be aligned with threaded inserts or mounting posts within the guitar body pickup cavity.

The pickup system may be positioned within the guitar body cavity with the mounting tabs resting on the pickup mounting ring or directly on the guitar body surface. Fasteners may be inserted through the mounting holes and threaded into the corresponding mounting points within the guitar body. The fasteners may be tightened to secure the base assembly in position while maintaining proper alignment of the pickup system relative to the guitar strings.

The mounting process may maintain compatibility with existing humbucker pickup installations, allowing the modular pickup system to be installed in guitars originally equipped with conventional humbucker pickups. The dimensional specifications of the base assembly and mounting tabs may conform to standard humbucker pickup dimensions, ensuring proper fit within existing pickup cavities without requiring modification to the guitar body.

Electrical connection of the pickup system to the guitar electronics may be accomplished through standard pickup wiring procedures. The output terminals of the base assembly may be connected to the guitar's wiring harness using conventional soldering techniques or quick-connect terminals. The electrical traces within the base assembly may route the signals from both modular coil assemblies to the output terminals, providing the necessary connections for integration with guitar volume and tone controls.

The installation process may be completed by verifying proper operation of both modular coil assemblies and confirming that the pickup system produces the expected electrical output when guitar strings are played. The modular nature of the system may allow individual coil assemblies to be tested and replaced if necessary without requiring removal of the entire pickup system from the guitar body. The standardized interfaces may ensure consistent performance regardless of which specific modular coil assemblies are installed in the mounting regions.

The modular electric guitar pickup system may operate through electromagnetic transduction principles that convert mechanical string vibrations into electrical signals suitable for amplification. The system may utilize the interaction between magnetic fields and conductive coil windings to generate electrical output when guitar strings vibrate within the magnetic field created by the pickup components.

The electromagnetic transduction process may begin with the establishment of a magnetic field pattern above the pickup system. The bar magnet may generate magnetic flux that flows through the pole pieces within each modular coil assembly, creating localized magnetic field concentrations that extend upward toward the guitar string positions. The magnetic field lines may form closed loops that pass through the bar magnet, the pole pieces, and the surrounding air space where the guitar strings are positioned.

When a guitar string vibrates within this magnetic field, the string motion may cause periodic disturbances in the magnetic flux pattern. The vibrating string may alternately move closer to and farther from the pole pieces, causing the magnetic field strength at the string position to fluctuate in accordance with the string's vibrational frequency and amplitude. These magnetic field variations may create changing magnetic flux through the coil windings surrounding each pole piece.

The changing magnetic flux through the coil windings may induce electrical voltage in accordance with electromagnetic induction principles. As the magnetic field strength varies due to string vibration, the flux through the coil windings may increase and decrease cyclically, generating an alternating voltage across the coil terminals. The magnitude of the induced voltage may correspond to the rate of change of magnetic flux, which may be proportional to the velocity and amplitude of the string vibration.

Each modular coil assembly may generate an electrical signal that represents the vibrational characteristics of the guitar strings positioned above the respective coil. The coil windings may convert the mechanical energy of string vibration into electrical energy through the electromagnetic induction process. The electrical signal generated by each coil may contain frequency components that correspond to the fundamental frequency and harmonics of the vibrating strings.

The dual-coil configuration of the pickup system may provide hum-canceling operation through the series connection of the first and second modular coil assemblies with opposite polarity. The electrical traces within the base assembly may connect the positive terminal of one coil assembly to the negative terminal of the other coil assembly, creating a series circuit where the two coils are wound or connected in opposite directions relative to each other.

External electromagnetic interference, such as that generated by power lines, fluorescent lights, or electronic devices, may induce unwanted voltages in both coil assemblies simultaneously. Since both coils may be positioned in close proximity and may have similar physical orientations, external electromagnetic fields may affect both coils in substantially the same manner. The interference signals induced in both coils may have similar amplitude and phase characteristics.

The opposite polarity connection between the two coil assemblies may cause the interference signals to cancel each other when the coil outputs are combined in the series circuit. The interference voltage induced in the first coil assembly may be equal in magnitude but opposite in polarity to the interference voltage induced in the second coil assembly. When these opposite-polarity interference signals are added together in the series connection, they may cancel each other, resulting in minimal interference in the combined output signal.

The musical signal generated by guitar string vibrations may be preserved in the hum-canceling configuration because the string-induced signals in both coils may be in phase with each other. The guitar strings may be positioned above both coil assemblies simultaneously, causing similar magnetic field disturbances in both coils when the strings vibrate. The string-induced signals may add constructively in the series connection, reinforcing the desired musical content while the interference signals cancel destructively.

The hum-canceling operation may be maintained regardless of which specific modular coil assemblies are installed in the mounting regions, provided that the coil assemblies are designed with compatible electrical characteristics. The electrical traces may establish the proper series connection and polarity relationship automatically when any compatible modular coil assemblies are installed in the first and second mounting regions.

The effectiveness of the hum-canceling operation may depend on the electrical and magnetic characteristics of the installed modular coil assemblies being sufficiently matched to ensure that external interference affects both coils similarly. Coil assemblies with similar inductance, resistance, and magnetic coupling characteristics may provide optimal hum-canceling performance when used together in the pickup system.

The modular nature of the system may allow musicians to experiment with different combinations of coil assemblies while maintaining the hum-canceling functionality. Different coil assemblies may provide varying tonal characteristics while preserving the interference rejection capabilities of the dual-coil configuration. The standardized electrical interface may ensure that the proper series connection and polarity relationship is maintained regardless of which specific coil assemblies are selected.

The pickup system may generate a combined output signal that represents the sum of the individual signals from both modular coil assemblies, with external interference substantially reduced through the cancellation effect. The combined signal may be routed through the electrical traces to the output terminals of the base assembly, where the signal may be transmitted to guitar amplification systems or recording equipment through standard guitar cables and connections.

The modular electric guitar pickup system may provide extensive customization capabilities that allow musicians to tailor the tonal characteristics of their instruments according to specific musical requirements or personal preferences. The modular design may enable independent modification of various pickup components without requiring complete system replacement, providing flexibility and cost-effectiveness compared to conventional pickup configurations.

Musicians may customize the pickup system by selecting modular coil assemblies with different electrical specifications to achieve desired tonal characteristics. Coil assemblies may be manufactured with varying numbers of wire turns, different wire gauges, or alternative winding patterns to produce distinct electromagnetic properties. Coil assemblies with higher turn counts may generate increased output levels and enhanced sensitivity to string vibrations, while assemblies with fewer turns may provide lower output with potentially reduced electromagnetic interference susceptibility.

The wire gauge used in different modular coil assemblies may influence the electrical resistance and inductance characteristics of the pickup system. Coil assemblies wound with thinner wire may exhibit higher resistance values, potentially producing warmer tonal qualities with reduced high-frequency response. Conversely, coil assemblies utilizing thicker wire may demonstrate lower resistance characteristics, potentially yielding brighter tonal qualities with enhanced high-frequency content.

Different winding patterns within the modular coil assemblies may create variations in the electromagnetic field distribution and coupling efficiency with guitar strings. Coil assemblies may be manufactured with uniform winding density, progressive winding patterns, or scatter-wound configurations to achieve specific tonal characteristics. Scatter-wound coil assemblies may produce more complex harmonic content and potentially reduced resonant peaks compared to uniformly wound assemblies.

The modular system may allow musicians to combine coil assemblies with different specifications in the same pickup installation, creating asymmetrical configurations that may produce unique tonal characteristics. A high-output coil assembly may be paired with a lower-output assembly to create balanced response across different string positions, or coil assemblies with different frequency response characteristics may be combined to achieve broader tonal range.

Musicians may also customize the magnetic characteristics of the pickup system by replacing the bar magnet with magnets constructed from different materials or having different magnetic field strengths. Alnico magnets may provide warm, vintage-style tonal characteristics with smooth compression and natural harmonic content. Ceramic magnets may deliver higher output levels with enhanced clarity and extended frequency response, particularly in the high-frequency range.

Neodymium magnets may offer extremely high magnetic field strength in compact dimensions, potentially providing exceptional string sensitivity and dynamic response. The high magnetic strength of neodymium magnets may enable the use of coil assemblies with fewer wire turns while maintaining adequate output levels, potentially reducing electromagnetic interference susceptibility and improving high-frequency response.

Different grades or compositions of the same magnet material may provide subtle variations in tonal characteristics. Alnico magnets may be available in various compositions such as Alnico II, Alnico V, or Alnico VIII, each offering distinct magnetic properties and associated tonal qualities. The modular design may allow musicians to experiment with different magnet types to identify the magnetic characteristics that complement their playing style and musical preferences.

The tool-free replacement capability of the bar magnet may enable real-time magnetic field adjustments during recording sessions or live performances. Musicians may swap magnets between songs or during breaks to achieve different tonal characteristics for specific musical passages or genres. The accessibility of the bar magnet when coil assemblies are removed may facilitate quick magnet changes without requiring disassembly of the pickup system or removal from the guitar body.

Pole piece height adjustment may provide additional customization options for optimizing the electromagnetic coupling between individual strings and the pickup system. Musicians may adjust the height of adjustable steel screws or steel slugs to compensate for variations in string gauge, playing technique, or desired output balance across different strings. Higher pole piece positions may increase the magnetic field strength at the corresponding string position, potentially enhancing output level and sensitivity for that string.

Lower pole piece positions may reduce the magnetic field interaction with the corresponding string, potentially decreasing output level and allowing other strings to be more prominent in the overall pickup response. The individual adjustment capability may enable musicians to create customized output balance across all six strings, compensating for natural volume differences between wound and unwound strings or accommodating specific playing techniques.

The combination of coil assembly replacement, magnet swapping, and pole piece adjustment may provide comprehensive tonal customization capabilities that exceed those available with conventional pickup systems. Musicians may systematically modify individual components to achieve precise tonal characteristics, creating personalized pickup configurations that may not be available in standard commercial pickup offerings.

The modular approach may provide significant cost advantages compared to purchasing multiple complete pickup assemblies to achieve tonal variety. Musicians may invest in a single base assembly and acquire multiple modular coil assemblies with different characteristics, allowing access to numerous tonal combinations at a fraction of the cost of equivalent complete pickup systems. The standardized interface may ensure that coil assemblies from different manufacturers or product lines may be compatible with the same base assembly, potentially expanding the available options for customization.

The reduced cost structure may encourage experimentation with different tonal configurations, allowing musicians to explore pickup characteristics that might otherwise be cost-prohibitive. The ability to purchase individual coil assemblies may enable gradual expansion of tonal options over time, allowing musicians to build comprehensive pickup collections according to their budget and musical development.

The modular system may maintain full compatibility with standard humbucker pickup routing and mounting hardware, ensuring that the customization benefits may be realized without requiring modifications to existing instruments. The base assembly dimensions and mounting tab configurations may conform to established humbucker pickup standards, allowing installation in guitars originally designed for conventional humbucker pickups.

The compatibility with standard pickup rings, mounting screws, and cavity dimensions may facilitate adoption of the modular system in existing instruments without requiring specialized installation procedures or modifications. Musicians may upgrade their existing humbucker-equipped guitars to modular pickup systems while preserving the original instrument aesthetics and maintaining compatibility with standard guitar hardware.

The real-time customization capabilities of the modular system may provide practical advantages during recording sessions, live performances, or practice sessions. Musicians may quickly swap coil assemblies between songs to achieve different tonal characteristics for specific musical passages, eliminating the need for multiple guitars or complex switching systems. The tool-free operation may enable coil changes during brief pauses in musical performance, providing access to diverse tonal palettes within a single instrument.

Recording engineers may utilize the modular system to optimize pickup characteristics for specific recording techniques or acoustic environments. Different coil assemblies may be selected to complement particular microphone placements, room acoustics, or amplifier characteristics, allowing fine-tuning of the recorded sound without requiring extensive post-processing or multiple recording passes.

The modular design may also facilitate maintenance and repair procedures by allowing individual coil assemblies to be removed for inspection, cleaning, or replacement without affecting the remaining pickup components. Damaged or worn coil assemblies may be replaced individually, potentially extending the service life of the overall pickup system and reducing maintenance costs compared to complete pickup replacement.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 100 | modular electric guitar pickup system |
| 102 | base assembly (e.g., metal base plate) |
| 104 | first coil mounting region |
| 106 | second coil mounting region |
| 108 | spring-loaded electrical connectors |
| 110 | first modular coil assembly |
| 112 | second modular coil assembly |
| 114 | bobbin |
| 116 | coil of wire |
| 118 | copper contact pads (e.g. copper contact pads for pogo pins and/or |
| | copper contact pads for coil wire termination) |
| 120 | bar magnet |
| 122 | steel slugs |
| 124 | adjustable steel screws |
| 126 | spring(s)/spring force(s) |
| 128 | electrical traces |
| 130 | mounting platform (e.g., metal base frame) |
| 132 | pogo pins (e.g., leads) |
| 134 | mounting tab |
| 136 | mounting holes |
| 138 | pickup cover |
| 140 | pole piece openings |
| 142 | spacing mechanisms (e.g., wooden shims, plastic shims, metal |
| | spacers) |
| 144 | bottom surface |
| 146 | top surface |
| 148 | housing |
| 150 | side walls |
| 152 | engagement mechanism |
| 200 | guitar |
| 202 | guitar strings |
| 204 | guitar body |

### GLOSSARY

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both of the terms “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order (e.g., first, second, third), a position, and/or an orientation are not limiting and are only referenced according to the views presented.

When an element is referred to as being “connected,” “coupled,” “mated,” “attached,” “fixed,” etc. to another element, the element can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, terms such as (i) “communicatively connected” or (ii) “fluidly connected” include (i) all variations of information exchange and routing between two electronic devices, including intermediary devices, networks, etc., connected wirelessly or not and (ii) all variations of fluid exchange and routing between two fluidic bodies, including intermediary fluid paths, flows, etc., connected indirectly or not.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A modular electric guitar pickup system configured to mount within a humbucker pickup cavity of an electric guitar, the system comprising:
a base assembly including a first coil mounting region and a second coil mounting region positioned adjacent to the first coil mounting region, and a plurality of spring-loaded electrical connectors positioned within the first and second coil mounting regions;
a first modular coil assembly configured to removably engage with the first coil mounting region, the first modular coil assembly including a bobbin, a coil of wire wound around the bobbin, and a plurality of copper contact pads positioned on a bottom surface of the first modular coil assembly and configured to electrically engage with corresponding spring-loaded electrical connectors in the first coil mounting region; and
a second modular coil assembly configured to removably engage with the second coil mounting region, the second modular coil assembly including a bobbin, a coil of wire wound around the bobbin, and a plurality of copper contact pads positioned on a bottom surface of the second modular coil assembly and configured to electrically engage with corresponding spring-loaded electrical connectors in the second coil mounting region, wherein the first and second modular coil assemblies are independently removable and replaceable without requiring soldering or specialty tools.

2. The modular electric guitar pickup system of claim 1, wherein the base assembly further comprises a bar magnet positioned between the first and second coil mounting regions, wherein the bar magnet becomes accessible for replacement when the first and second modular coil assemblies are removed.

3. The modular electric guitar pickup system of claim 1, wherein each of the first and second modular coil assemblies further comprises steel slugs positioned to interact with guitar strings.

4. The modular electric guitar pickup system of claim 1, wherein each of the first and second modular coil assemblies further comprises adjustable steel screws positioned to interact with guitar strings.

5. The modular electric guitar pickup system of claim 1, wherein the spring-loaded electrical connectors comprise pogo pins configured to provide both electrical connection and mechanical retention of the modular coil assemblies.

6. The modular electric guitar pickup system of claim 5, wherein the base assembly further comprises electrical traces connecting the pogo pins to output terminals for connection to guitar electronics.

7. The modular electric guitar pickup system of claim 1, wherein the first and second modular coil assemblies have standardized dimensions and electrical interfaces, allowing interchangeable use between the first and second coil mounting regions.

8. The modular electric guitar pickup system of claim 1, wherein the copper contact pads are positioned to align with the spring-loaded electrical connectors when the modular coil assemblies are properly seated in their respective mounting regions.

9. The modular electric guitar pickup system of claim 2, wherein the bar magnet is removable without requiring tools when the first and second modular coil assemblies are removed from the base assembly.

10. The modular electric guitar pickup system of claim 3, wherein the steel slugs are adjustable in height to modify the magnetic field strength relative to the guitar strings.

11. The modular electric guitar pickup system of claim 6, wherein the electrical traces are configured to connect the first and second modular coil assemblies in series with opposite polarity to provide hum-canceling operation.

12. A modular coil assembly for an electric guitar pickup, comprising:
a bobbin;
a coil of wire wound around the bobbin, the coil having first and second ends;
a plurality of copper contact pads positioned on a bottom surface of the modular coil assembly, wherein the first and second ends of the coil are electrically connected to respective copper contact pads; and
a plurality of pole pieces configured to interact with guitar strings, wherein the modular coil assembly is configured to removably engage with a base assembly through electrical and mechanical connection of the copper contact pads with corresponding spring-loaded electrical connectors.

13. The modular coil assembly of claim 12, wherein the pole pieces comprise steel slugs positioned to interact with guitar strings.

14. The modular coil assembly of claim 12, wherein the pole pieces comprise adjustable steel screws positioned to interact with guitar strings.

15. The modular coil assembly of claim 14, wherein the adjustable steel screws are configured to be adjusted in height to modify magnetic field strength relative to the guitar strings.

16. The modular coil assembly of claim 12, wherein the copper contact pads are positioned to align with corresponding spring-loaded electrical connectors when the modular coil assembly is properly seated in a coil mounting region of the base assembly.

17. A base assembly for a modular electric guitar pickup system, comprising:
a mounting platform configured to fit within a standard humbucker pickup cavity;
a first coil mounting region and a second coil mounting region positioned on the mounting platform;
a plurality of spring-loaded electrical connectors positioned within each of the first and second coil mounting regions, the spring-loaded electrical connectors configured to provide both electrical connection and mechanical retention for modular coil assemblies; and
electrical traces connecting the spring-loaded electrical connectors to output terminals for connection to guitar electronics.

18. The base assembly of claim 17, further comprising a bar magnet positioned between the first and second coil mounting regions, wherein the bar magnet becomes accessible for replacement when modular coil assemblies are removed from the first and second coil mounting regions.

19. The base assembly of claim 18, wherein the bar magnet is removable without requiring tools when the modular coil assemblies are removed from the base assembly.

20. The base assembly of claim 17, wherein the spring-loaded electrical connectors comprise pogo pins, and wherein the electrical traces are configured to connect modular coil assemblies in series with opposite polarity to provide hum-canceling operation.
